(19) United States
(12) Patent Application Publication
(10) Pub. No.: US 2014/0203167 A1
(43) Pub. Date: Jul. 24, 2014

(54) OPTICAL SENSING INTERFACE WITH MODULATION GRATINGS

(71) Applicant: QUALCOMM MEMS TECHNOLOGIES, INC., San Diego, CA (US)

(72) Inventors: Evgeni Yurij Poliakov, San Mateo, CA (US); Jonathan Charles Griffiths, Fremont, CA (US); Vladimir Vasilievich Yankov, Washington Twp., NJ (US)

(73) Assignee: QUALCOMM MEMS TECHNOLOGIES, INC., San Diego, CA (US)

(21) Appl. No.: 13/745,434

(22) Filed: Jan. 18, 2013

(51) Int. Cl. G01J 1/04; G06F 3/03

(52) U.S. Cl. CPC G01J 1/0425; G06F 3/0304
USPC 250/206.1; 250/227.14

(57) ABSTRACT

This disclosure provides implementations of systems, devices, components, methods, and techniques for producing an optical sensing interface capable of detecting touches or gestures. In one aspect, an apparatus includes a light source, a photo-detector, and a substrate. The apparatus includes an emitting waveguide that extends at least partially over the substrate and that is configured to propagate light from the light source to one or more corresponding emitting portions. Each emitting portion is capable of emitting at least a portion of the light outwards from a plane defining the substrate. The apparatus further includes a sensing waveguide that extends at least partially over the substrate and that includes one or more sensing portions. Each sensing portion is arranged proximate an emitting portion and is capable of receiving light scattered by an object over the corresponding emitting portion. The sensing waveguide is configured to propagate the received light to the photo-detector.

### TECHNICAL FIELD

This disclosure relates generally to optical sensing interfaces, and more specifically to optical touchscreen interfaces.

### DESCRIPTION OF THE RELATED TECHNOLOGY

Touchscreen displays have become commonplace in the realm of digital media. For example, digital e-book readers, mobile handsets, smartphones, tablet computers, and various multimedia devices are commonly equipped with touchscreen displays. As the name indicates, touchscreen displays generally include two essential components: a display and a touchscreen interface. The touchscreen interface can generally be positioned in front of the display such that the touchscreen interface covers most or all of the viewable area of the display. The touchscreen interface is configured to transfer data, commands, and responses from the outside world into the device. For example, the touchscreen interface may be used to move a cursor, icon, or other visual object, to navigate menus, and to make selections with respect to the GUI on the display. More specifically, the touchscreen interface can be configured to recognize the touch and position (among other possible attributes) of one or more human fingers or a stylus that contact the touchscreen interface and to send the data to a processor that controls the display.

There are a number of different touchscreen sensing technologies in use including resistive sensing, capacitive sensing, and surface acoustic wave (SAW) sensing. Another type of touchscreen sensing technology used is an infrared grid. Generally, an infrared grid touchscreen includes an array of light-emitting diodes (LEDs) and corresponding photo-detectors arranged along the edges of the touchscreen. The LEDs emit infrared (IR) light beams across the screen in horizontal and vertical patterns. The photo-detectors detect disruptions in the patterns caused by, for example, the presence of a finger or stylus. The choice of which sensing technology to use in a particular application can depend on one or more of a variety of factors including the type of display, the quality or clarity of the display desired (for example, the contrast of the display), cost, resistance to contaminants, resilience to wear, and resolution, among others.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus. The apparatus includes a light source, a photo-detector, and a substrate. The apparatus additionally includes an emitting waveguide that extends at least partially over the substrate, the emitting waveguide configured to propagate light from the light source to one or more corresponding emitting portions arranged along the emitting waveguide. Each emitting portion is configured to be capable of emitting at least a portion of the light from the emitting waveguide outwards from a plane defining the substrate. The apparatus further includes a sensing waveguide that extends at least partially over the substrate, the sensing waveguide including one or more sensing portions arranged along the sensing waveguide. Each sensing portion is arranged proximate a corresponding emitting portion and is configured to be capable of receiving light scattered by an object over the corresponding emitting portion. The sensing waveguide is configured to propagate the received light to the photo-detector.

In some implementations, the apparatus further includes a transparent lower cladding layer, a transparent core layer arranged over the lower cladding layer, the core layer including the emitting waveguide and the sensing waveguide, and a transparent upper cladding layer arranged over the core layer. In some implementations, the apparatus further comprises a transparent cover layer arranged over the upper cladding layer. In some implementations, the core layer includes a plurality of emitting waveguides and a plurality of sensing waveguides. The apparatus can further include a distributing waveguide optically coupled with the light source and configured to receive light emitted from the light source and to propagate the received light along the distributing waveguide. The distributing waveguide includes a plurality of turning portions, each turning portion arranged along the distributing waveguide and configured to reflect a portion of the light received by the turning portion into a corresponding one of the plurality of emitting waveguides. In some implementations, the reflected portions of light entering each emitting waveguide have substantially the same intensity. In some other implementations, each turning portion in the distributing waveguide reflects substantially the same percentage of the intensity of the light received by the turning portion as the other turning portions in the distributing waveguide reflect. Each turning portion can include a set of turning gratings. In some implementations, each set of turning gratings is configured as a set of nano-gratings. Each emitting portion and each sensing portion can include a set of gratings. In some implementations, each set of emitting or sensing gratings also is configured as a set of nano-gratings.

In some implementations, the photo-detector is part of an array of photo-detectors, each photo-detector of the array of photo-detectors being configured to receive light from a corresponding one of the sensing waveguides. Each emitting portion and the corresponding proximately-arranged sensing portion can be configured as a sensing point. In some such implementations, the apparatus is communicatively-coupled to a processor configured to determine a location of the sensing point when the photo-detector detects a threshold amount of light associated with the sensing point.

In some implementations, the emitting waveguides and the sensing waveguides extend along a width of the substrate along a direction of an x-axis of the substrate, and the distributing waveguide extends along a length of the substrate along a direction of a y-axis of the substrate orthogonal to the x-axis. In some such implementations, each emitting waveguide includes only one emitting portion and each sensing waveguide includes only one sensing portion. In some such implementations, each sensing point is associated with a particular x-coordinate position and a particular y-coordinate position because the emitting waveguides and corresponding sensing waveguides are arranged in a sufficiently dense periodic fashion along the length of the apparatus such that both an x- and a y-coordinate position of the object can be determined based on detection of light from a single sensing waveguide.

In some other implementations, each emitting waveguide includes a plurality of emitting portions and each sensing waveguide includes a plurality of sensing portions. In some such implementations, each of the sensing points along a corresponding pair of adjacent emitting and sensing waveguides is associated with the same particular y-coordinate position. In some such implementations, the apparatus is a first apparatus of a display device and the display device further includes a second apparatus disposed over or with the first apparatus. The second apparatus includes a plurality of second emitting waveguides that each extend at least partially over the substrate, each second emitting waveguide configured to propagate light to a plurality of corresponding second emitting portions arranged along the second emitting waveguide. Each second emitting portion is configured to be capable of emitting at least a portion of the light from the second emitting waveguide outwards from the plane defining the substrate. The second apparatus further includes a plurality of second sensing waveguides that each extend at least partially over the substrate, each second sensing waveguide including a plurality of second sensing portions arranged along the second sensing waveguide. Each second sensing portion is disposed proximate a corresponding emitting portion and is configured to be capable of receiving light scattered by an object over the corresponding second emitting portion. The second sensing waveguide is configured to propagate the received light to a photo-detector. In some such implementations, the second emitting waveguides and the second sensing waveguides extend along the length of the substrate along the direction of the y-axis, the second apparatus includes a second distributing waveguide that extends along the length of the substrate along the direction of the x-axis, and each of the sensing points of the second apparatus along a corresponding pair of adjacent second emitting and second sensing waveguides is associated with the same particular x-coordinate position. In some such implementations, the sensing points of the second apparatus are positioned directly over, or are positioned proximately offset from, the sensing points of the first apparatus, and when an object is suitably positioned on or over at least one sensing point of the first apparatus the object is also positioned over at least one sensing point of the second apparatus such that the processor is configured to determine an x-coordinate position of the object based on information from the second apparatus and to determine a y-coordinate position of the object based on information from the first apparatus. In some implementations, the second distributing waveguide of the second apparatus receives light from the light source of the first apparatus and distributes the light to the second emitting waveguides.

In another aspect, an apparatus includes light generating means, photo-detection means, and a substrate. The apparatus additionally includes first guiding means that extend at least partially over the substrate. The first guiding means is configured to propagate light from the light generation means to one or more corresponding emitting means arranged along the first guiding means. Each emitting means is configured to be capable of emitting at least a portion of the light from the first guiding means outwards from a plane defining the substrate. The apparatus further includes second guiding means that extends at least partially over the substrate. The second guiding means including one or more sensing means arranged along the second guiding means. Each sensing means is arranged proximate a corresponding emitting means, and is configured to be capable of receiving light scattered by an object over the corresponding emitting means. The second guiding means is configured to propagate the received light to the photo-detection means. In some implementations, each emitting means and each sensing means includes a set of nano-gratings.

Details of one or more implementations of the subject matter described in this specification are set forth in the accompanying drawings and the description below. Although the examples provided in this disclosure may be described in terms of, or in combination with, EMS and MEMS-based displays, the touchscreen concepts provided herein may apply to other types of displays, such as liquid crystal displays (LCDs), organic light-emitting diode (OLED) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a depiction of an example computing or display device.

FIG. 2 shows an example implementation of an optical sensing interface.

FIG. 3 shows an oblique plan view of an example portion of a planar waveguide having a number of gratings in the core of the waveguide.

FIG. 4A shows a top plan view of a portion of an optical sensing interface.

FIG. 4B shows a side plan view of the portion of the optical sensing interface of FIG. 4A.

FIG. 5 shows an implementation in which the density of the sensing points of the optical sensing interface has been increased by a factor of two relative to the optical sensing interface of FIG. 2.

FIG. 6 shows an implementation in which the density of the sensing points of the optical sensing interface has been further increased relative to the optical sensing interface of FIG. 5.

FIG. 7 shows an implementation in which the density of the sensing points of the optical sensing interface has been further increased relative to the optical sensing interface of FIG. 6.

FIG. 8 shows an implementation of an optical sensing interface in which each emitting waveguide includes a plurality of emitting portions and each sensing waveguide includes a plurality of sensing portions.

FIG. 9 shows an implementation of an optical sensing interface that includes two overlying optical sensing interfaces.

FIG. 10 shows an implementation of an optical sensing interface that includes two overlying optical sensing interfaces that share a light source and a photo-detector array.

FIG. 11 shows another implementation of an optical sensing interface that includes two overlying optical sensing interfaces.

FIG. 12A is an isometric view illustration depicting two adjacent interferometric modulator (IMOD) display elements in a series or array of display elements of an IMOD display device.

FIG. 12B is a system block diagram illustrating an electronic device incorporating an IMOD-based display including a three element by three element array of IMOD display elements.

FIGS. 13A and 13B are system block diagrams illustrating a display device that includes a plurality of IMOD display elements.

Like reference numbers and designations in the various drawings indicate like elements.

### DETAILED DESCRIPTION

The disclosed implementations include examples of systems, apparatus, devices, components, methods, and techniques for producing an optical sensing interface and for using an optical sensing interface to detect touches or gestures applied on or over a display. Some implementations relate more specifically to optical touchscreen interfaces that utilize an array of waveguides to distribute light and a plurality of gratings to selectively reflect, scatter and receive light in conjunction with the waveguides. For example, a distributing waveguide can distribute light from a light source to a plurality of emitting waveguides that extend across at least a portion of a display. Each emitting waveguide can be configured to emit light at one or more portions along the emitting waveguide. In some implementations, each of the emitting portions includes a number of gratings configured to scatter a portion of the light propagating through the emitting waveguide. The optical sensing interface also includes a photo-detector and a plurality of sensing waveguides that extend across at least a portion of the display. Each sensing waveguide can be configured to receive light at one or more portions along the sensing waveguide and to propagate the received light to the photo-detector for detection. In some implementations, each of the sensing portions includes a number of gratings configured to receive light scattered from an object near an adjacent proximate emitting portion and to propagate the received light through the sensing waveguide to the photo-detector.

Particular implementations of the subject matter described in this disclosure can be implemented to realize one or more of the following potential advantages. Some implementations are particularly useful or applicable to handheld computing devices in which a primary source or method of user input is a touchscreen or other sensing interface disposed on or over a display of the device. In some implementations, the optical sensing interfaces described herein can be configured to detect single- and multi-point touches or gestures including near-field touches or gestures; that is, touches or gestures that do not necessarily physically contact a surface of the sensing interface or display of the device. In contrast to some traditional IR-based touchscreens that require multiple light sources, in some implementations, only a single light source may be used. Additionally, while traditional IR-based touchscreens are based on sensing disruptions or drops in the amplitudes of light signals, and thus can suffer from shadowing effects making them unusable for detecting multi-point touches or gestures, implementations described herein are based on sensing amplitude increases and are not as susceptible to shadowing. In some implementations, some or all of the waveguides of the optical sensing interfaces described herein can be produced using the same lower cladding layer, the same core materials, and the same upper cladding layer. In some implementations, the array of waveguides can be constructed on or in a flexible substrate. Additionally, the substrate and waveguides can be made very thin: for example, on the order of a few microns. Furthermore, the use of nano-gratings as components of sensing points, as described below, enables very high resolution: for example, at or below the sub-millimeter range.

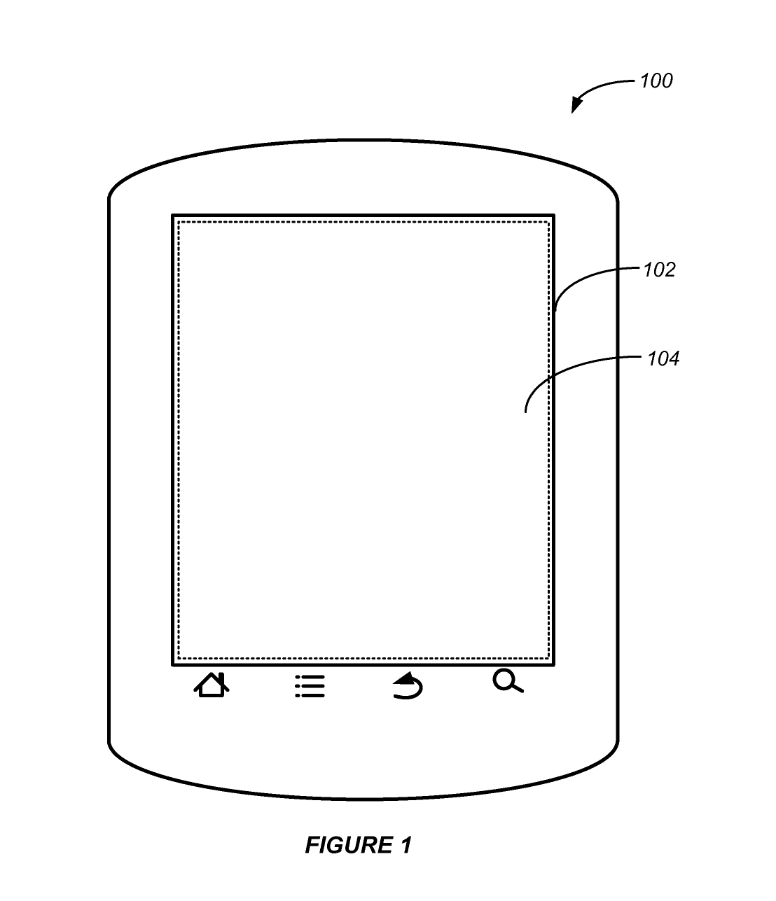

FIG. 1 shows a depiction of an example computing or display device 100. The device 100 can be configured in a variety of forms and to perform a variety of functions according to a variety of implementations or applications. In some implementations, the device 100 is a handheld computing device or mobile electronic device having a display 102. In some such implementations, the device 100 can be a digital e-book reader, a mobile handset, a smartphone, a tablet computer, a smartbook device, a netbook computer, or a multimedia device such as an mp3 player. In some other implementations, the device 100 can be a laptop computer, a desktop computer, or a general display monitor.

The display 102 can include any suitable display screen technology. For example, the display 102 can be a MEMS-based display such as an interferometric modulator (IMOD)-based display or a digital MEMS shutter (DMS) display, an LCD display, or an LED display. The display 102 can generally be configured to display a graphical user interface (GUI) that facilitates interaction between a user of the device 100 and the operating system and other applications executing (or “running”) on the device 100. For example, the GUI may generally present programs, files, and operational options with graphical images. The graphical images may include, for example, windows, fields, dialog boxes, menus, other text, icons, buttons, cursors, scroll bars, among other presentations. During operation of the device 100, the user (hereinafter “user” and “viewer” may be used interchangeably) can select, activate, or manipulate various graphical images (hereinafter also referred to as “visual objects”) displayed on the display 102 to initiate function(s) associated with the visual object, to manipulate the visual object, or to input information to the device 100.

The device 100 includes one or more user input devices, including an optical sensing interface 104, that are operatively coupled to one or more processors or processing circuits (not shown) within the device 100. In some implementations, the optical sensing interface 104 can be configured as, or referred to as, a touchscreen interface. The optical sensing interface 104 can generally be in communication with a sensing interface controller (not shown). Generally, the optical sensing interface 104 and other input devices are configured to transfer data, commands, and responses from the outside world into the device 100. For example, the input devices may be used to move a cursor, icon, or other visual object, to navigate menus, and to make selections with respect to the GUI on the display 102. In some implementations, the input devices, such as the optical sensing interface 104, can be used to perform other operations including paging, scrolling, panning, dragging, “flicking,” “flinging,” and zooming, among other possibilities. Other input devices include buttons or keys, computer “mice,” trackballs, touchpads, and joysticks, among others.

The optical sensing interface 104 is generally configured to recognize the touch and position (among other possible attributes) of a “touch event” on or over the display 102. The touch event can be a touch, such as from one or more human fingers or a stylus that physically contacts a part of the sensing interface 104. In some implementations, the optical sensing interface 104 also can be configured to recognize near-field or other gestures applied over the optical sensing interface 104; that is, the optical sensing interface 104 can be configured to sense the positioning and motion of an object, such as a human finger or stylus, in close proximity to a part of the sensing interface 104. Such gestures applied over the optical sensing interface 104 may intermittently physically or directly contact an upper (or outer) surface of the optical sensing interface 104. Thus, for purposes of some implementations herein, touch gestures include gestures that are sensed by the sensing interface 104 regardless of whether or not the gestures physically or directly contact the sensing device.

A processor, alone or in conjunction with other components including a sensing interface controller and the optical sensing interface 104, interprets each touch event and executes one or more instructions to perform an action or actions based on the touch event. In some implementations, the optical sensing interface 104 is configured to sense and distinguish between multiple touches, different magnitudes of touches, as well as the velocity (e.g., speed and direction) or acceleration of a touch as one or more fingers (or a stylus or other suitable object) are moved across or over the optical sensing interface 104. The optical sensing interface 104 can generally be positioned in front of the display 102 such that the optical sensing interface covers most or all of the viewable area of the display 102.

In some implementations, the optical sensing interface 104 registers touch events, generates signals in response to the registered touch events, and sends these signals to a sensing interface controller. The sensing interface controller then processes these signals and sends the processed data to the processor. In some implementations, the functionality of the sensing interface controller can be incorporated into or integrated with the processor. For example, a processor can be configured to receive touch event signals from the optical sensing interface 104 and to process or translate these signals into computer input events.

In some implementations, the optical sensing interface 104 is capable of recognizing multiple touch events that occur at different locations on the touch sensitive surface of the optical sensing interface 104 at the same or similar time; that is, the optical sensing interface 104 allows for multiple contact points or “touch points” to be detected and subsequently tracked simultaneously. In some implementations, the optical sensing interface 104 generates separate tracking signals for each touch point on the optical sensing interface 104 at the same time. Such an implementation may be referred to as a “multi-touch” interface.

In some implementations, the device 100 is operable to recognize gestures applied to the optical sensing interface 104 and to control aspects of the device 100 based on the gestures. For example, a gesture may be defined as a stylized single or multi-point touch event interaction with the optical sensing interface 104 that is mapped to one or more specific computing operations. As described, the gestures may be made through various hand and, more particularly, finger motions. The optical sensing interface 104 receives the gestures and the one or more processors execute instructions to carry out operations associated with the gestures. In some implementations, a memory (not shown) of the device 100 includes a gestural operation program and an associated gesture library, which may be a part of the operating system or a separate application. The gestural operation program can generally include a set of instructions that recognizes the occurrence of gestures and informs the processor what instructions to execute or actions to perform in response to the gestures. In some implementations, for example, when a user performs one or more gestures on or over the optical sensing interface 104, the optical sensing interface 104 relays gesture information to the processor, which, using and executing instructions from the memory, including the gestural operation program, interpret the gestures and control different components of the device 100 based on the gestures. For example, the gestures may be identified as commands for performing actions in applications stored in the memory, modifying or manipulating visual objects displayed by display 102, and modifying data stored in the memory. For example, the gestures may initiate commands associated with dragging, flicking, flinging, scrolling, paging, panning, zooming, rotating, and sizing. Additionally, the commands also may be associated with launching a particular program or application, opening a file or document, viewing a menu, viewing a video, making a selection, or executing other instructions.

In some implementations, the device 100, and particularly the optical sensing interface 104 and the processor, is/are configured to immediately recognize the gestures applied to the optical sensing interface 104 such that actions associated with the gestures can be implemented at the same time (or substantially the same time as perceived by a viewer) as the gesture. That is, the gesture and the corresponding action occur effectively simultaneously. In some implementations, a visual object can be continuously manipulated based on the gesture applied to the optical sensing interface 104. That is, there may be a direct relationship between a gesture being applied to the optical sensing interface 104 and the visual object displayed by the display 102. For example, during a scrolling gesture, the visual object (such as text) displayed on the display 102 moves with the associated gesture (either in the same or the opposite direction for example); that is, with the finger or other input across the optical sensing interface 104. As another example, during a dragging operation, the visual object (such as an icon, picture, or other image) being dragged moves across the display based on the velocity of the gesture. However, it some implementations, a visual object may continue to move after the gesture has ended. For example, during some scrolling operations, or during a flinging or flicking operation, the visual object's velocity and acceleration can be based on the velocity and acceleration associated with the gesture and may continue to move after the gesture has ceased based on the velocity or acceleration of the previously applied gesture.

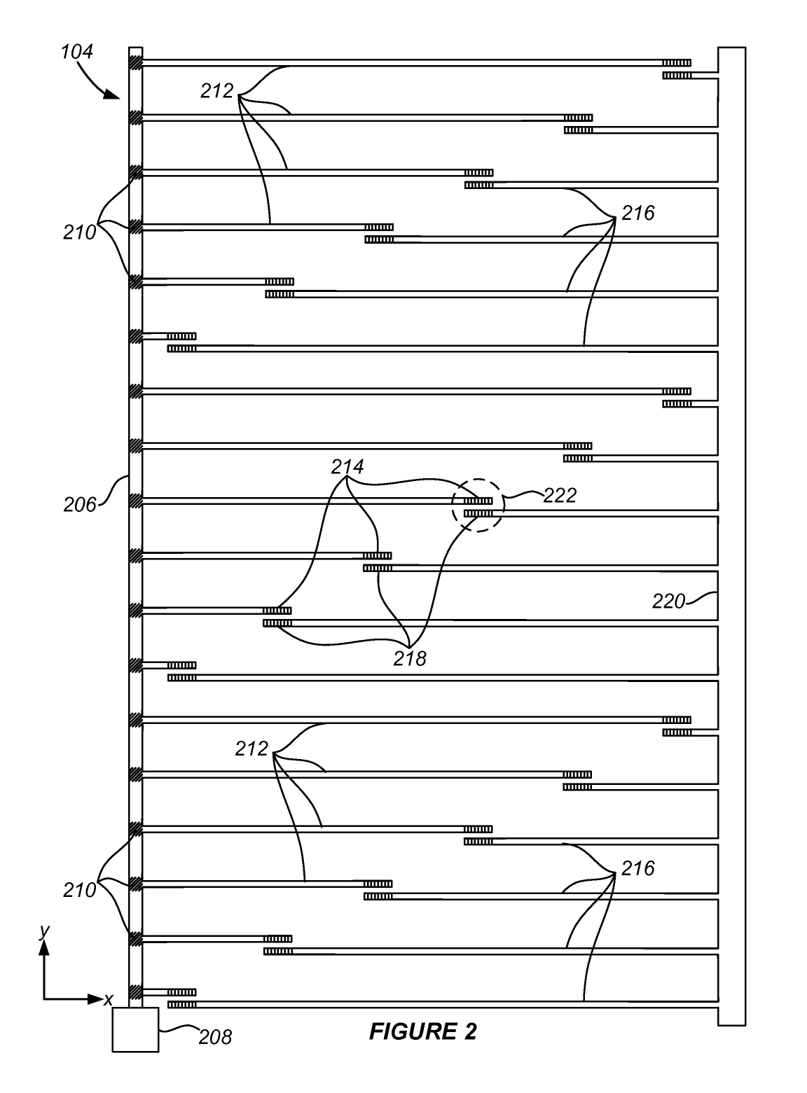

FIG. 2 shows an example implementation of an optical sensing interface 104. The optical sensing interface 104 includes an array of waveguides that distribute or propagate light. The array of waveguides include a distributing waveguide 206 that receives light from a photodiode, laser diode (LD), other laser source, or other light source 208. In some implementations, the light source 208 emits coherent, collimated light at an infra-red wavelength. For example, the light source 208 may emit light at a wavelength in the range of approximately 800 nanometers (nm) to approximately 850 nm. In some other implementations, other light sources or other wavelengths may be used.

In the illustrated implementation, the distributing waveguide 206 propagates the light received from the light source 208 along the length (or parallel to a y-axis) of the device 100. A plurality of turning portions 210 are arranged along the length of the distributing waveguide 206. In some implementations, each turning portion 210 includes a set of turning gratings for reflecting a portion of the light incident on the turning gratings into the corresponding emitting waveguide 212. In some such implementations, the turning gratings can be configured as nano-gratings passing or reflecting only certain wavelengths or ranges of wavelengths. For example, the turning gratings can be similar to Fiber-Bragg gratings in that they pass only certain wavelengths of light. Each turning portion 210 is configured to reflect a portion of the light received by the turning portion 210. For example, each turning portion 210 can typically reflect a small portion (e.g., less than 10%) and transmit the remainder through to the next turning portion 210.

Light reflected by each turning portion 210 is optically coupled into a corresponding one of a plurality of emitting waveguides 212. In the illustrated implementation, each of the emitting waveguides 212 extends along the width (or parallel to an x-axis) of the device 100. In some implementations, the turned light entering each emitting waveguide 212 has substantially the same intensity (for example, each emitting waveguide 212 receives substantially the same amount of light as the other emitting waveguides). In some other implementations, each turning portion 210 in the distributing waveguide 206 reflects substantially the same percentage of the intensity of the light received by the turning portion 210 as the other turning portions 210 in the distributing waveguide 206 reflect (for example, each emitting waveguide 212 receives approximately 10%—or some other suitable percentage—of the light incident on the corresponding turning portion 210). For example, if each turning portion 210 is configured to reflect 10% of the light received by the turning portion into the corresponding emitting waveguide 212, then the first turning portion 210 after the light source 208 would reflect 10% of the intensity of the light received from the light source and transmit 90% of the light received from the light source. In this example, the second turning portion 210 would receive the 90% intensity from the first turning portion 210, and would reflect 10% of that light—9% of the original light intensity—into the corresponding emitting waveguide 212 and transmit 90% of that light—81% of the original light intensity—to the third turning portion 210. Each emitting waveguide 212 propagates the light received by the corresponding turning portion 210 along the emitting waveguide 212 towards an emitting portion 214. In some implementations, each emitting portion 214 includes a set of gratings. For example, each set of gratings of each emitting portion 214 can be configured as a nano-grating or similar to a Fiber-Bragg grating. Each emitting portion 214 is configured to emit, leak, or scatter a portion of the light received by the emitting portion 214.

The optical sensing interface 104 also includes a corresponding plurality of sensing waveguides 216. In the illustrated implementation, each of the sensing waveguides 216 also extends along the width (or parallel to the x-axis) of the device 100. Each sensing waveguide 216 is optically coupled to or with a photo-detector array 220. In some implementations, the photo-detector array 220 includes a plurality of individual photo-detectors (not shown)—each individual photo-detector of the array being configured for detecting light from a single one of the sensing waveguides 216 or from a subset of the sensing waveguides 216. Each sensing waveguide 216 includes one or more sensing portions 218. Each sensing portion 218 is arranged proximate a corresponding one of the emitting portions 214 of an emitting waveguide 212. For example, in some implementations, each emitting waveguide 212, at least at the emitting portion 214, can be spaced apart from the nearest sensing waveguide 216, at least at the sensing portion 218, by approximately the width of the emitting or sensing waveguide. In some other implementations, other widths or spacings may be appropriate. In some implementations, each sensing portion 218 includes a set of gratings. For example, each set of gratings of each sensing portion 218 can be configured as a nano-grating or similar to a Fiber-Bragg grating. Each sensing portion 218 is configured to receive light scattered onto or into the gratings of the sensing portion 218 (by, for example, a finger or other object proximate the sensing portion 218) and to propagate the received light along the sensing waveguide 216 for transfer into, and detection by, the photo-detector array 220. Each sensing portion 218 and corresponding proximate emitting portion 214 can be referred to as a sensing point 222.

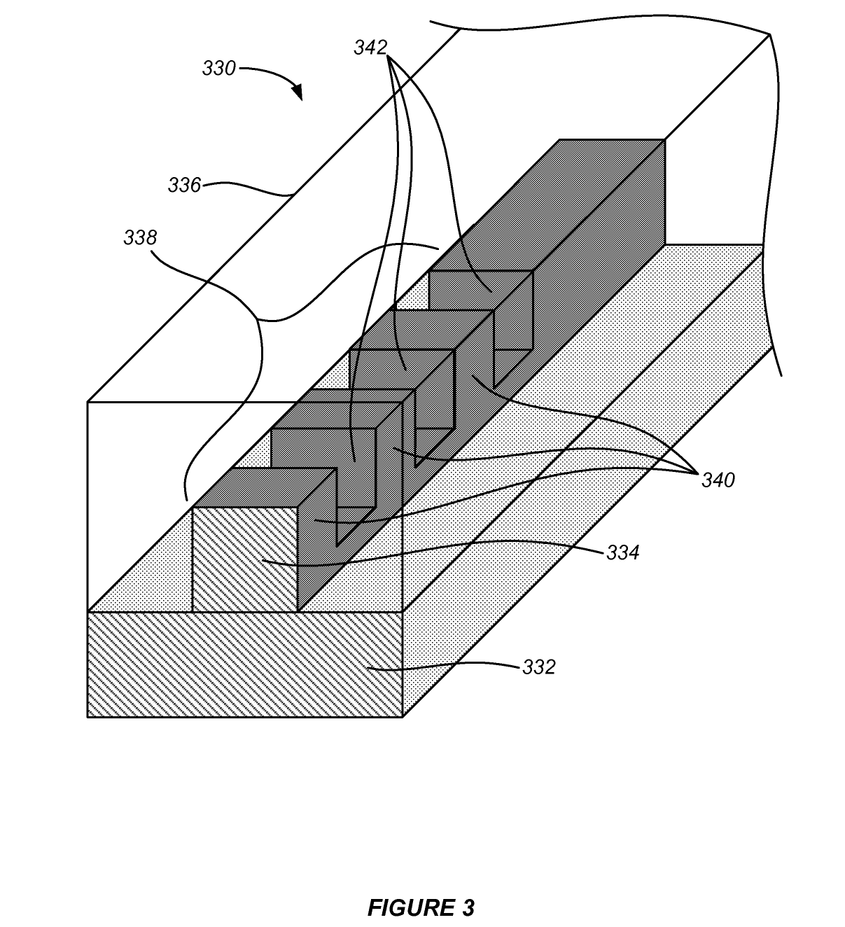

In some implementations, all of the waveguides—the distributing waveguide 206, the plurality of emitting waveguides 212, and the plurality of sensing waveguides 216—are planar waveguides. FIG. 3 shows an oblique plan view of an example portion of a planar waveguide 330 having a number of gratings in the core of the waveguide. The oblique plan view shown in FIG. 3 is taken along a plane perpendicular to the longitudinal axis of the waveguide 330. For example, the waveguide 330 can be configured for use as the emitting waveguide 212 or the sensing waveguide 216. The waveguide 330 includes a lower cladding layer 332 (shown in light shading), a core 334 (shown in dark shading), and an upper cladding layer 336 (shown as clear). The waveguide 330 further includes a portion 338 along the core 334 of the waveguide that includes a number of gratings 340. Where the waveguide is configured as an emitting waveguide 212, the portion 338 is configured as an emitting portion 214. Where the waveguide is configured as a sensing waveguide 216, the portion 338 is configured as a sensing portion 218. In some implementations, all of the aforementioned waveguides—the distributing waveguide 206, the plurality of emitting waveguides 212, and the plurality of sensing waveguides 216—are formed using the same lower cladding layer 332, the same core material(s), and the same upper cladding layer 334. In some implementations, the optical sensing interface 104 additionally includes a transparent cover layer arranged over the upper cladding layer 336. In some such implementations, the cover layer is deformable under finger pressure. This may, for example, allow for increased scattering.

In some implementations, the optical sensing interface 104 is constructed on a transparent substrate (not shown) upon which the lower cladding layer 332 is grown, deposited, or otherwise disposed. In some implementations, the substrate can be a flexible substrate. The cores of the distributing waveguide 206, the emitting waveguides 212, and the sensing waveguides 216 are then grown, deposited, or otherwise disposed over the lower cladding layer 332. The upper cladding layer is grown, deposited, or otherwise disposed over the cores and the lower cladding layer 332. In some implementations in which a flexible substrate is used, the cores of the distributing waveguide 206, the emitting waveguides 212, and the sensing waveguides 216 can be fabricated through one or more nanoimprint lithographic and/or roll-to-roll replication techniques. These techniques can result in very thin waveguides with nanometer scale dimensions and features. Such techniques also can be considerably less expensive than more traditional fabrication techniques including electron beam lithography, ion beam deposition, or other typical semiconductor fabrication processes. In some implementations, the lower cladding layer and the upper cladding layer are formed of silicon dioxide or “silica” (SiO₂) or another suitable material that is transparent to visible light. In some implementations, the core is formed of doped SiO₂. For example, in some implementations, the core of each waveguide is formed of heavily-doped SiO₂ in which the dopant is germanium (Ge), although other dopants can be used. Generally, like traditional waveguides, the outer cladding layers have indices of refraction that are lower than the index of refraction of the core. For example, in one implementation, the core has an index of refraction, n, of 1.455, while the lower and upper cladding layers indices of refraction, n, of 1.444. In some other implementations, a different dopant, a combination of two or more dopants, or a different dopant concentration can be used to fabricate a core having a different index of refraction to provide a greater or smaller difference relative to the index of refraction of the cladding layers.

In some implementations, to produce the gratings 340 for the portion 338 of the core 340 (e.g., the gratings for the emitting portion 214 or the sensing portion 218), the core 340 is etched prior to deposition of the upper cladding layer 336 to produce a series of gratings 340 and a series of notches or gaps 342 of specified spacings and of specified periods. Generally, the spacings of the gaps 342 and the differences in the indices of refraction of the gratings 340 and whatever material is in the gaps 342 (for example, the upper cladding layer material) result in the various transmission and reflection coefficients for the light incident on the gratings 340. For example, the lengths of each of the gratings 340 along the waveguide 330 can be in the range of tens to hundreds or thousands of nanometers while the gaps 342 between adjacent gratings 340 also can be in the range of tens to hundreds or thousands of nanometers. Such gratings may be referred to as nano-gratings. However, generally, the desired dimensions of the gratings 340 and the dimensions of the gaps 342 will depend on the wavelength (or wavelengths) of the light from the light source 208. For example, the length of each grating 340 or spacing 342 can be approximately λ/2 where λ is the wavelength of the light used (for example, 850 nm). In some implementations, the gaps 342 are filled with the upper cladding layer 336 when the upper cladding layer 336 is deposited. In some other implementations, the gaps 342 can be filled with a different material. As described above, the gratings of the emitting portions 214 or the gratings of the sensing portions 218 also can be configured as or similar to Fiber-Bragg gratings. In some other implementations, the gratings can be formed from doping or otherwise periodically changing the material properties of the emitting and sensing portions 214 and 218. The turning portions 210 of the distributing waveguide 206 can be implemented with turning gratings (e.g., 45° turning gratings) produced similar to the gratings 340 but at an angle (e.g., 45° relative to the length of the distributing waveguide 206 to reflect portions of the light propagating along the distributing waveguide 206 into the emitting waveguides 212. In some implementations, the turning portions 210 also can be configured as or similar to Fiber-Bragg gratings.

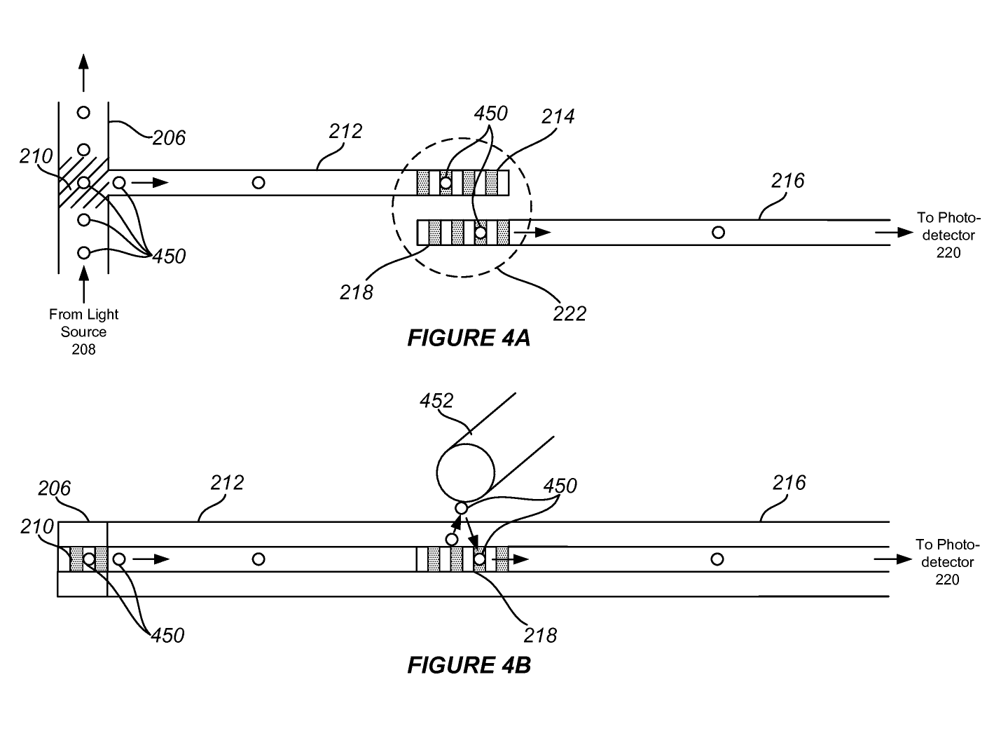

FIG. 4A shows a top plan view of a portion of an optical sensing interface 104. FIG. 4B shows a side plan view of the portion of the optical sensing interface of FIG. 4A. The portion shown in FIGS. 4A and 4B includes portions of a distributing waveguide 206, an emitting waveguide 212 and emitting portion 214, and a sensing waveguide 216 and sensing portion 218. As described above, the emitting portion 214 and the proximate sensing portion 218 may be referred to as a sensing point 222. In some implementations, during normal operation of the device 100, when no object—such as a finger—is touching or positioned over the sensing point 222, very little or virtually none of the light—shown as photons 450—emitted by the emitting portion 214 is scattered into the corresponding proximate sensing portion 218. However, as shown in FIGS. 4A and 4B, when an object 452—such as a finger—is positioned on or proximately over a sensing point 222, then a portion of the photons 450 emitted from the emitting portion 214 of the sensing point is reflected or scattered off of the object 452 and into the gratings of the proximate sensing portion 218 of the sensing point 222. Photons 450 received by the sensing portion 218 are then propagated along the sensing waveguide 216 for detection by the photo-detector array 220. In this way, when a certain threshold of light is detected by the photo-detector array 220, a touch event is detected by the photo-detector array 220 in conjunction with the processor or other components of the device 100. Additionally, because the gratings in the sensing portions 218 can be configured to transmit only the wavelength of the light transmitted from the light source 208, the operation of the optical sensing interface 104 can be nonresponsive to changes in ambient illumination conditions.

As described above, in some implementations, each emitting waveguide 212 may receive a different intensity of light than the other emitting waveguides (for example, in an implementation where the turning portions 210 each turn an equal percentage of the light received by the turning portion into the corresponding waveguide as described above). In some such implementations, the corresponding sensing waveguides 216 each receive a baseline amount of scattered light proportional to the amount of light received by the corresponding emitting waveguide 212. In some such implementations, the photo-detector array 220 can be configured to distinguish between the sensing waveguides 216 based on the amount of light sensed by the photo-detector array 220. That is, in some implementations, the photo-detector array 220 does not require a sub-photo-detector dedicated to each sensing waveguide 216. In some implementations, the threshold sensitivities (e.g., for registering a touch event) for each of the sensing waveguides 216 also can be different and proportional to the amount of light received by the corresponding emitting waveguide 212.

Depending on the arrangement and density of the sensing points 222, and the resolution desired, different detection and position location schemes can be utilized to determine a location of a touch event or a movement of a touch gesture. In the example shown in FIG. 2, each emitting waveguide 212 includes one and only one emitting portion 214, and each sensing waveguide 216 includes one and only one sensing portion 218. In this way, each pair of adjacent emitting and sensing waveguides 212 and 216 include a single sensing point 222. However, if the spacing between adjacent pairs is too large then there may be portions of the optical sensing interface 104 where a finger or other object would not register a touch event. There are a number of techniques to ensure that all portions of the optical sensing interface 104 register finger or object touches (given the size of a finger or fingertip or a stylus or other suitable object) for a given desired touch resolution and one or more of these techniques may be utilized in various implementations.

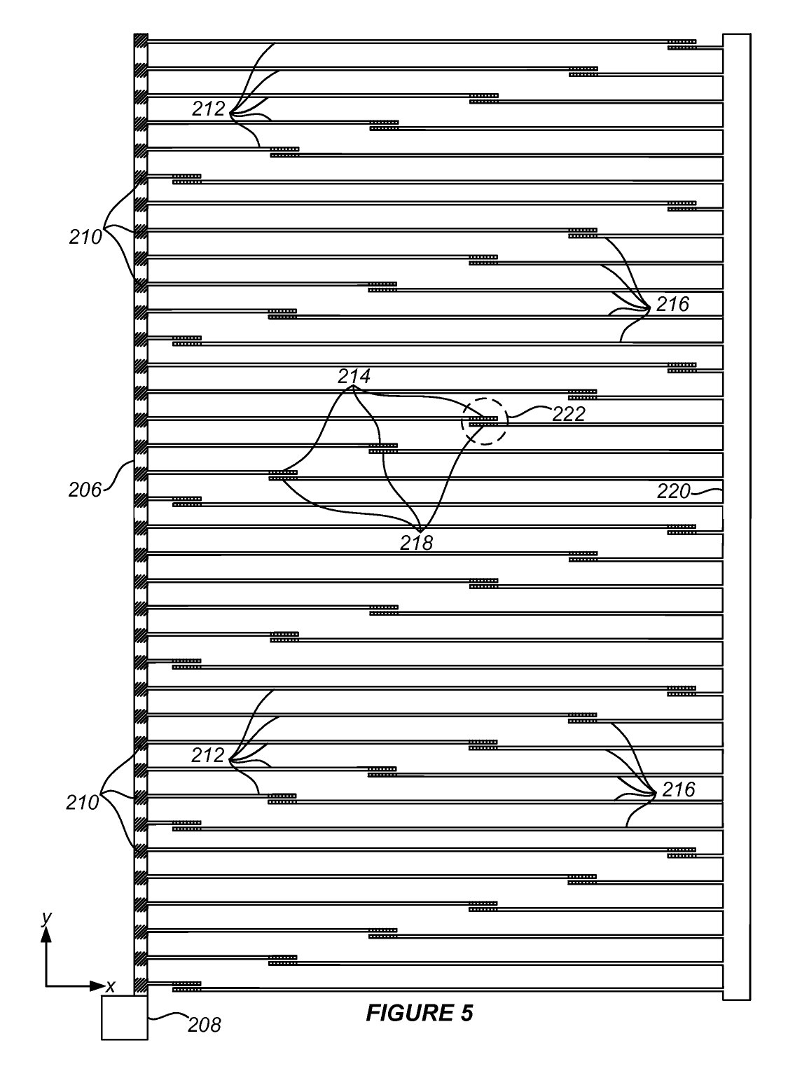

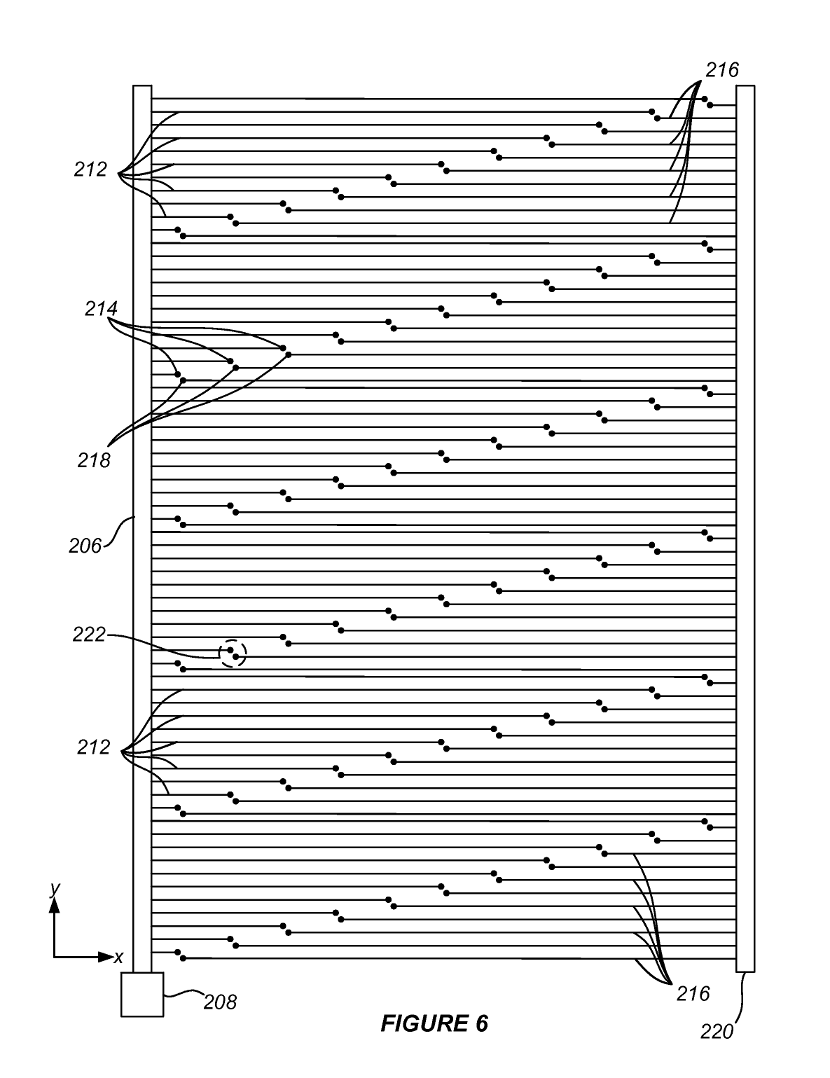

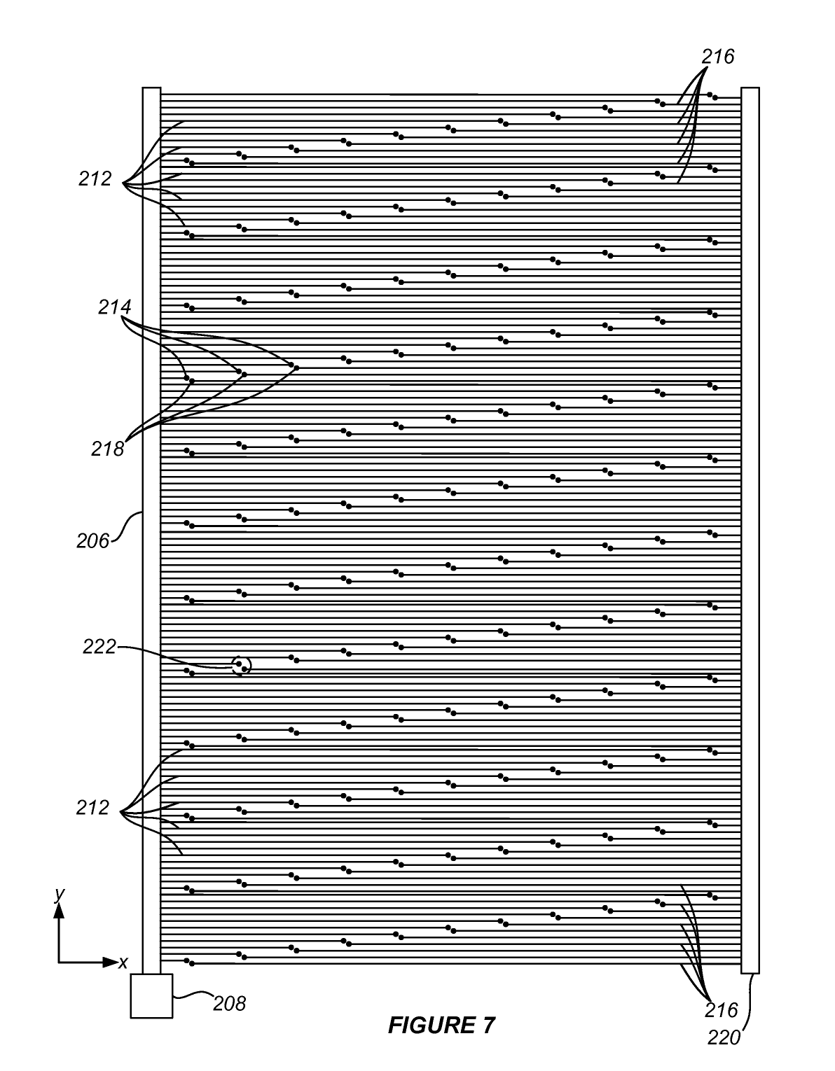

One technique involves increasing the density of the sensing points 222 by reducing the spacing between adjacent pairs of emitting and sensing waveguides 212 and 216. FIG. 5 shows an implementation in which the density of the sensing points 222 of the optical sensing interface has been increased by a factor of two relative to the optical sensing interface of FIG. 2. For example, in the optical sensing interface of FIG. 5, the spacings between adjacent pairs of emitting and sensing waveguides 212 and 216 have been reduced by a factor of two. However, depending on the size of the screen and the desired resolution, greater densities of the sensing points 222 may be required or desired. FIG. 6 shows an implementation in which the density of the sensing points 222 of the optical sensing interface has been further increased relative to the optical sensing interface of FIG. 5 (note that the turning portions 210 have not been illustrated in FIG. 6 for clarity of illustration, and that the emitting portions 214 and sensing portions 218 have been illustrated as “dots” or small circles in the sensing points 222 for ease of illustration). FIG. 7 shows an implementation in which the density of the sensing points 222 of the optical sensing interface has been further increased relative to the optical sensing interface of FIG. 6 (Again, the turning portions 210 have not been illustrated in FIG. 7, and the emitting portions 214 and sensing portions 218 have been illustrated as “dots” or small circles in the sensing points 222).

In such implementations, each sensing point 222 can be pre-associated with a particular x-coordinate position and a particular y-coordinate position in, for example, a memory of the device 100. To ensure that a touch event can be detected anywhere on or proximately over the optical sensing interface 104, the emitting waveguides 212 and the corresponding sensing waveguides 216 are arranged in a sufficiently dense periodic fashion along the length of the device 100 such that both an x- and a y-coordinate position of an object can be determined based on detection, by the photo-detector array 220, of light from a single sensing waveguide 216.

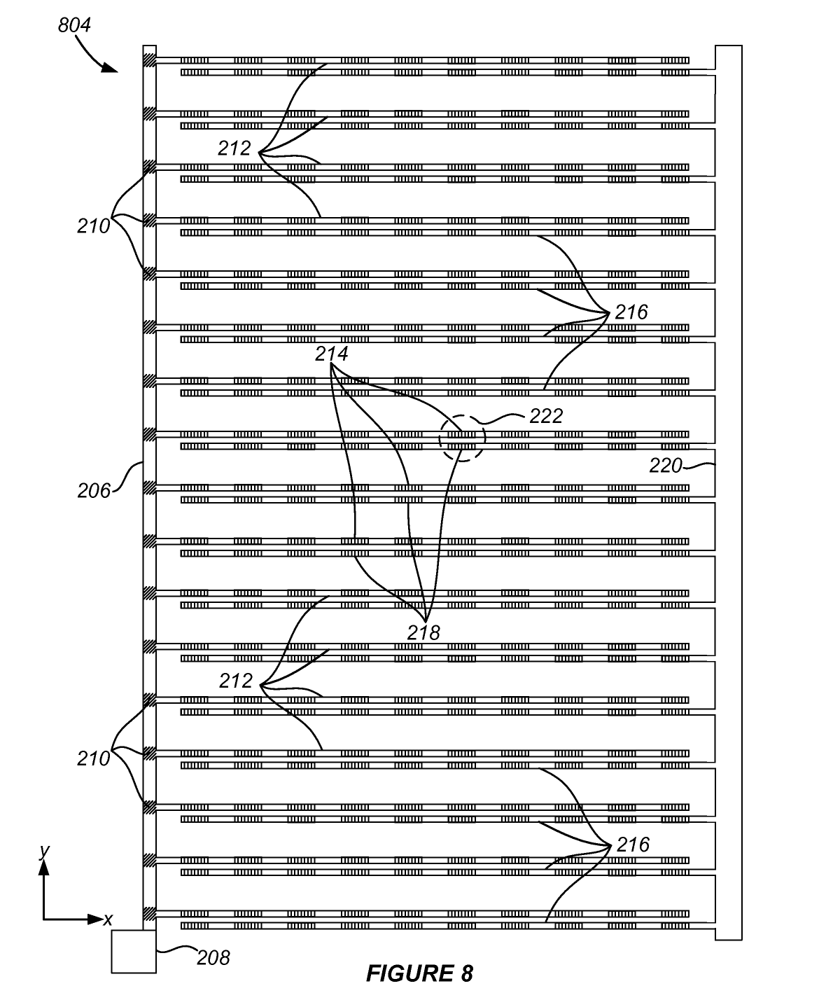

In some other implementations, the density of the sensing points can be increased by increasing the number of emitting portions 214 and sensing portions 218 along each of the emitting waveguides 212 and sensing waveguides 216, respectively. FIG. 8 shows an implementation of an optical sensing interface 804 in which each emitting waveguide 212 includes a plurality of emitting portions 214 and each sensing waveguide 216 includes a plurality of sensing portions 218. For example, in the implementation shown in FIG. 8 for didactic purposes, each pair of emitting and sensing waveguides includes ten sensing points 222. However, given that all of the sensing portions 218 along a given sensing waveguide 216 propagate down the same sensing waveguide and are optically coupled to the same photo-detector of the photo-detector array 220, in some implementations, all of the sensing points 222 along a given pair of emitting and sensing waveguides are associated (e.g., in a memory of the device 100) with the same coordinate position—for example, the same y-coordinate position.

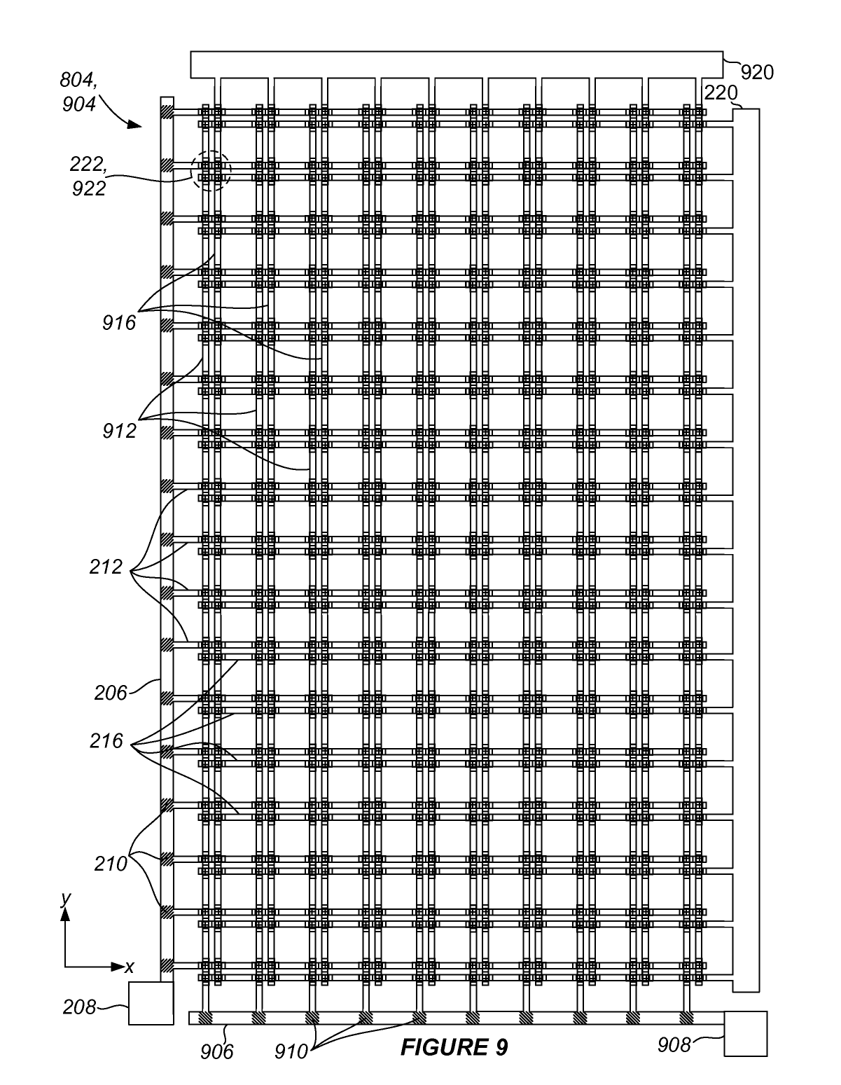

In some such implementations, to obtain the x-coordinate position, the device 100 further includes a second optical sensing interface. FIG. 9 shows an implementation of an optical sensing interface that includes two overlying optical sensing interfaces 804 and 904. The second optical sensing interface 904 is substantially similar to the first optical sensing interface 804 and is arranged over or with the first optical sensing interface 804. The second optical sensing interface 904 includes a separate light source 908 and a separate photo-detector array 920. The second optical sensing interface 904 is disposed substantially perpendicular to the first optical sensing interface 804 such that the emitting and the sensing waveguides 912 and 916, respectively, of the second optical sensing interface 904 extend along the length of the display along the direction of the y-axis. In such an implementation, the second optical sensing interface 904 can include a second distributing waveguide 906 that extends along the width of the display along the direction of the x-axis and that includes a plurality of turning portions 910.

In some implementations, each of the sensing points 922 of the second optical sensing interface 904 along a corresponding pair of adjacent second emitting and second sensing waveguides 912 and 916, respectively, is associated with the same particular x-coordinate position. In some implementations, the sensing points 922 of the second optical sensing interface 904 are positioned directly over, or are positioned proximately offset from, the sensing points 222 of the first optical sensing interface 804. In this way, when an object, such as a finger, is suitably positioned on or over the optical sensing interfaces, the object is positioned on or over at least one sensing point of the first optical sensing interface 804 and at least one sensing point of the second optical sensing interface 904 such that the processor is configured to determine an x-coordinate position of the object based on information from the second optical sensing interface 904 and to determine a y-coordinate position of the object based on information from the first optical sensing interface 804.

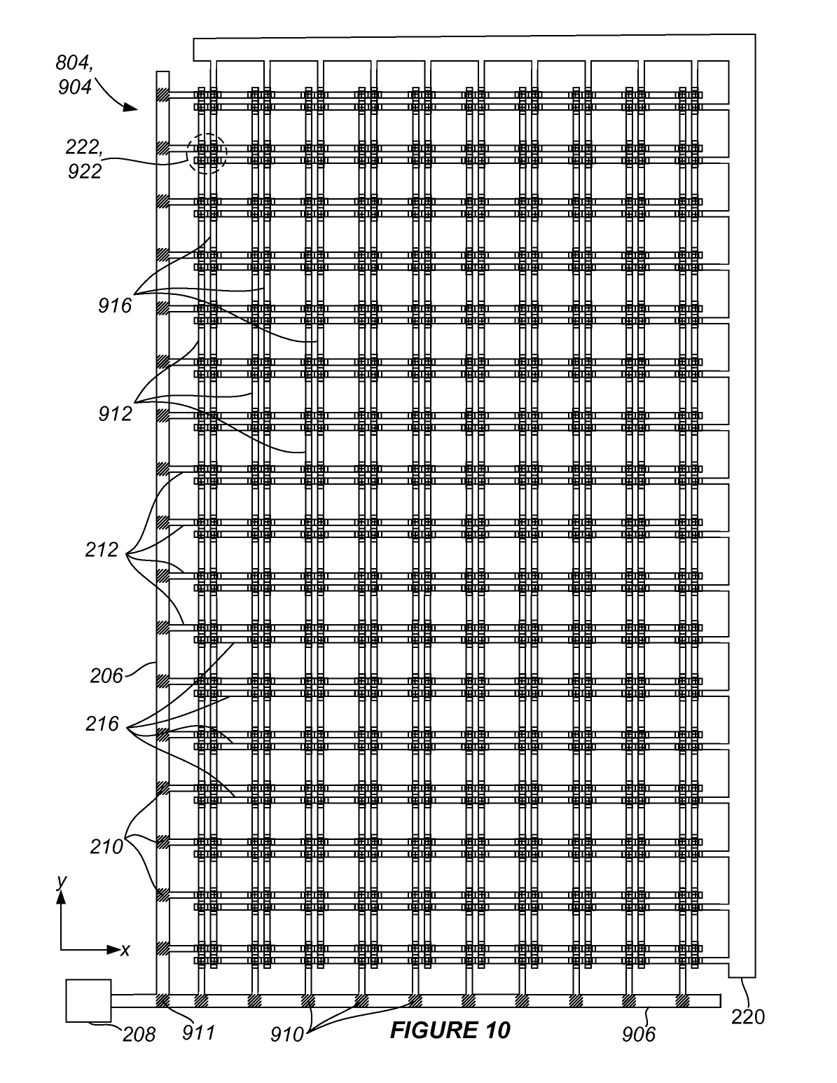

In some other implementations, the second optical sensing interface 904 can share one or both of the light source 208 or photo-detector array 220 of the first optical sensing interface 804. FIG. 10 shows an implementation of an optical sensing interface that includes two overlying optical sensing interfaces that share a light source and a photo-detector array. For example, the optical sensing interface of FIG. 10 can be similar to the optical sensing interface of FIG. 9 except that the light source 208 emits light that is then incident on a turning grating 911 which reflects a portion of the light (for example, approximately half) down the first distributing waveguide 206 and which transmits a portion of the light (for example, approximately half) down the second distributing waveguide 906. Additionally, as described above, the photo-detector array 220 can generally include an individual photo-detector for each first sensing waveguide 216 and for each second sensing waveguide 916.

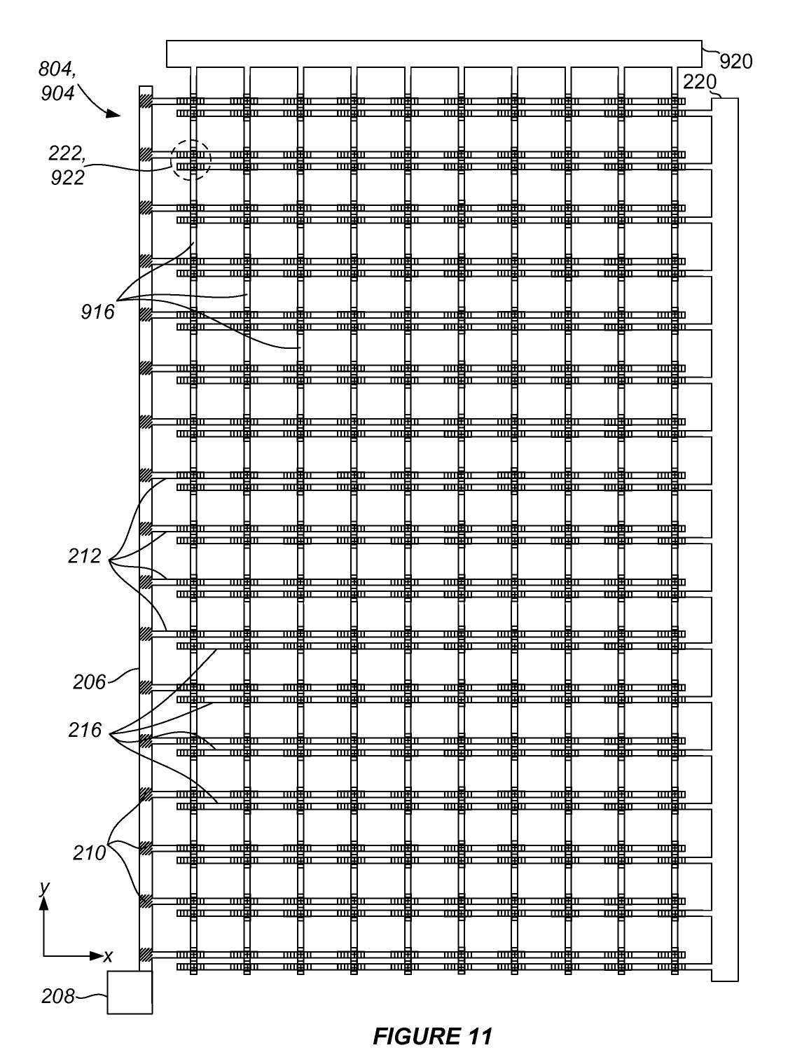

FIG. 11 shows another implementation of an optical sensing interface that includes two overlying optical sensing interfaces. For example, the optical sensing interface of FIG. 11 can be similar to the optical sensing interface of FIG. 9 except that the second overlying optical sensing interface 904 does not include a light source 908 nor emitting waveguides 912. Rather, any light scattered into a sensing portion of a sensing waveguide 916 of the second optical sensing interface 904 is first emitted by the underlying emitting portion of the emitting waveguide 212 of the first optical sensing interface 804 before being scattered by an object above the interfaces. In this manner, an emitting portion of an emitting waveguide 212 of the first optical sensing interface 804 can serve as the light emitter for both the sensing waveguide 216 of the first optical sensing interface 804 as well as for the sensing waveguide 916 of the second optical sensing interface 904.

When an optical sensing interface such as those described above with reference to FIGS. 2-11 is disposed over or integrated with a display, it can be referred to as a touchscreen display. While the description is directed to certain implementations for the purposes of describing the innovative aspects of this disclosure, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. Thus, the teachings are not intended to be limited to the implementations depicted solely in the Figures, but instead have wide applicability as will be readily apparent to one having ordinary skill in the art.

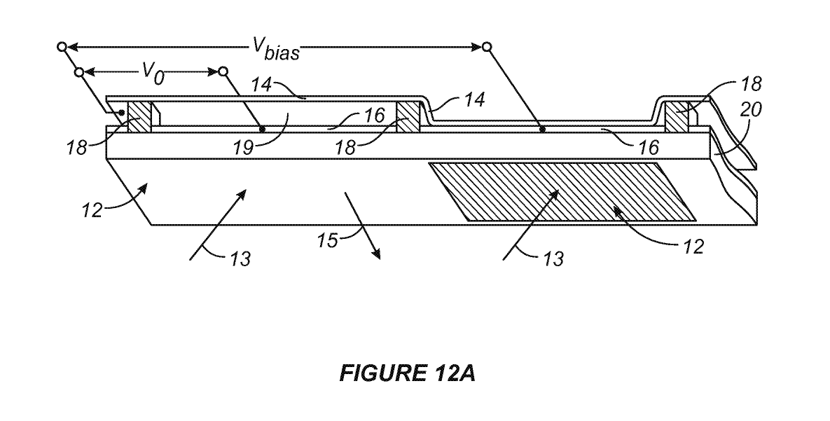

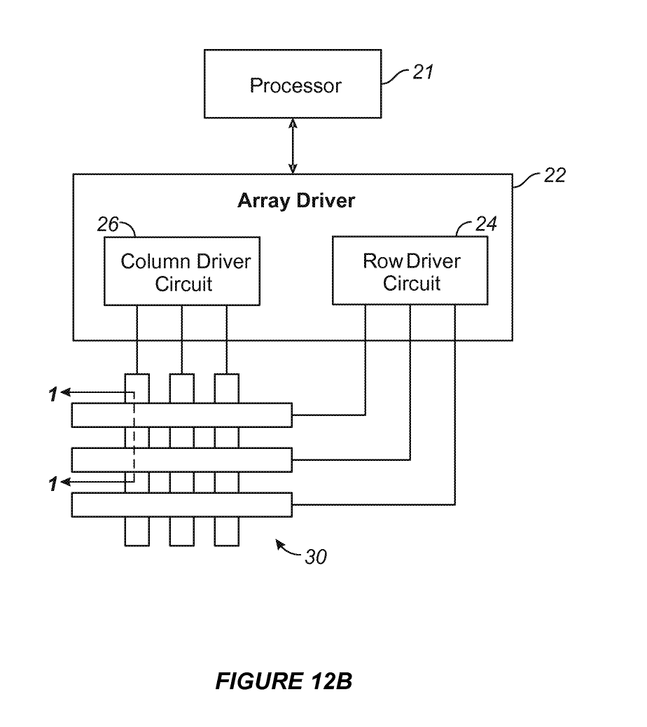

FIG. 12A is an isometric view illustration depicting two adjacent interferometric modulator (IMOD) display elements in a series or array of display elements of an IMOD display device. For example, the IMOD display device can be suitable for use as the display device 100. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved. Although the IMOD display elements illustrated here have only two states, it is understood that some implementations of IMOD display elements can include devices capable of having multiple states, such as, for example, eight color states. In some implementations, the eight color states include white, black, and six other colors (such as, for example, blue, cyan, green, orange, yellow, red). Such multiple-state IMODs are capable of being “relaxed” and “closed” as described above, but are also capable of having, for example, six intermediate states with the movable reflective layer 14 in various intermediate positions between “relaxed” and “closed.”

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 12A includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

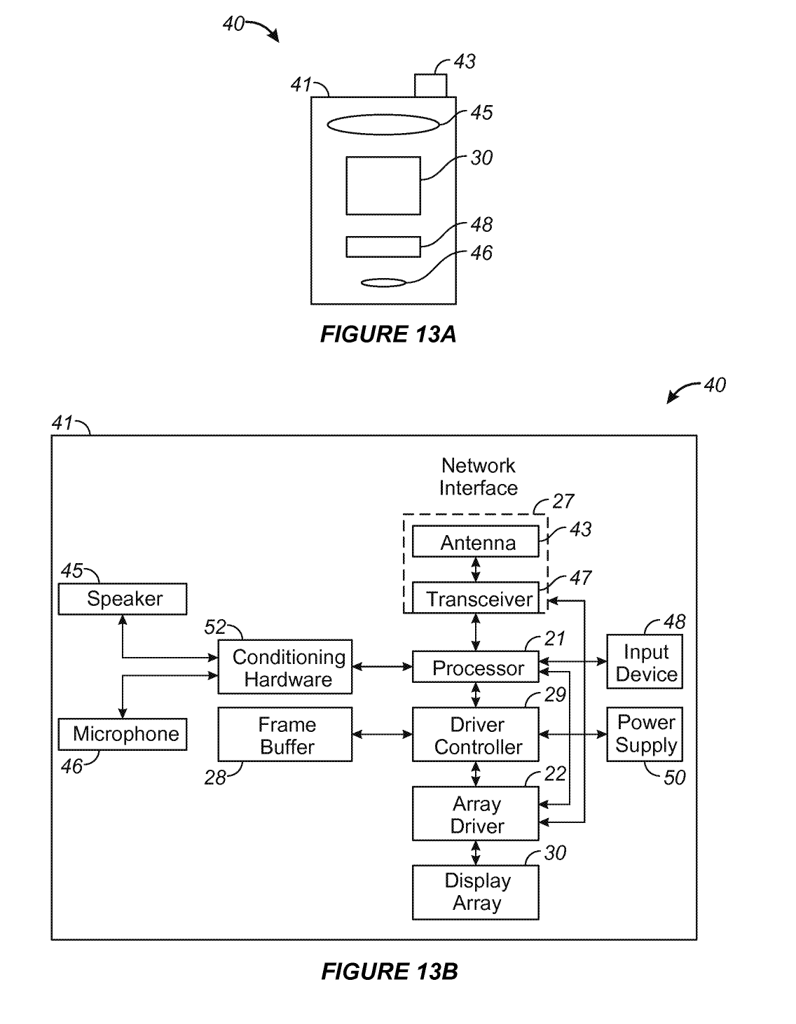

In FIG. 12A, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, one implementation of which includes a fixed reflective layer and a movable layer which is partially transmissive and partially reflective, may be configured to be viewed from the opposite side of a substrate as the display elements 12 of FIG. 13A and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 12A, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 12A. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 12B is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application. In some implementations, the processor 21 is the same as, or a part of the same chip or package as, the processor described above. As described above, the processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 12A is shown by the lines 1-1 in FIG. 12B. Although FIG. 12B illustrates a 3×3 array of IMOD display elements for the sake of clarity, the display array 30 may contain a very large number of IMOD display elements, and may have a different number of IMOD display elements in rows than in columns, and vice versa.

FIGS. 13A and 13B are system block diagrams illustrating a display device 40 that includes a plurality of IMOD display elements. For example, the display device can be suitable for use as display device 100 described above. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 (which can be or which can include the optical sensing interface 104 described above) and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

Some of the components of the display device 40 are schematically illustrated in FIG. 13A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 12A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.8A, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the image data generated by the processor 21 either directly from the processor 21 or from the frame buffer 28 and can re-format the image data appropriately for high speed transmission to the array driver 22. In some implementations, the driver controller 29 can re-format the image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. In addition to including an optical sensing interface as described above, the input device 48 also can collectively include a keypad, such as a QWERTY keyboard or a telephone keypad, a button, a switch, a rocker, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a light source;
a photo-detector;
a substrate;
an emitting waveguide that extends at least partially over the substrate, the emitting waveguide configured to propagate light from the light source to one or more corresponding emitting portions arranged along the emitting waveguide, each emitting portion configured to be capable of emitting at least a portion of the light from the emitting waveguide outwards from a plane defining the substrate; and
a sensing waveguide that extends at least partially over the substrate, the sensing waveguide including one or more sensing portions arranged along the sensing waveguide, each sensing portion arranged proximate a corresponding emitting portion, each sensing portion configured to be capable of receiving light scattered by an object over the corresponding emitting portion, the sensing waveguide configured to propagate the received light to the photo-detector.

2. The apparatus of claim 1, wherein the apparatus further includes:
a transparent lower cladding layer;
a transparent core layer arranged over the lower cladding layer, the core layer including the emitting waveguide and the sensing waveguide; and
a transparent upper cladding layer arranged over the core layer.

3. The apparatus of claim 2, further comprising a transparent cover layer arranged over the upper cladding layer.

4. The apparatus of claim 2, wherein the core layer includes a plurality of emitting waveguides and a plurality of sensing waveguides.

5. The apparatus of claim 4, further comprising a distributing waveguide optically coupled with the light source and configured to receive light emitted from the light source and to propagate the received light along the distributing waveguide, the distributing waveguide including a plurality of turning portions, each turning portion arranged along the distributing waveguide and configured to reflect a portion of the light received by the turning portion into a corresponding one of the plurality of emitting waveguides.

6. The apparatus of claim 5, wherein the reflected portions of light entering each emitting waveguide have substantially the same intensity.

7. The apparatus of claim 5, wherein each turning portion in the distributing waveguide reflects substantially the same percentage of the intensity of the light received by the turning portion as the other turning portions in the distributing waveguide reflect.

8. The apparatus of claim 5, wherein each turning portion includes a set of turning gratings.

9. The apparatus of claim 8, wherein each set of turning gratings is configured as a set of nano-gratings.

10. The apparatus of claim 1, wherein each emitting portion and each sensing portion includes a set of gratings.

11. The apparatus of claim 10, wherein each set of gratings is configured as a set of nano-gratings.

12. The apparatus of claim 4, wherein the photo-detector is part of an array of photo-detectors, each photo-detector of the array of photo-detectors being configured to receive light from a corresponding one of the sensing waveguides.

13. The apparatus of claim 4, wherein:
each emitting portion and the corresponding proximately-arranged sensing portion are configured as a sensing point; and
the apparatus is communicatively-coupled to a processor configured to determine a location of the sensing point when the photo-detector detects a threshold amount of light associated with the sensing point.

14. The apparatus of claim 13, wherein
the emitting waveguides and the sensing waveguides extend along a width of the substrate along a direction of an x-axis of the substrate;
the distributing waveguide extends along a length of the substrate along a direction of a y-axis of the substrate orthogonal to the x-axis;
each emitting waveguide includes only one emitting portion;
each sensing waveguide includes only one sensing portion;
each sensing point is associated with a particular x-coordinate position and a particular y-coordinate position; and
the emitting waveguides and corresponding sensing waveguides are arranged in a sufficiently dense periodic fashion along the length of the apparatus such that both an x- and a y-coordinate position of the object can be determined based on detection of light from a single sensing waveguide.

15. The apparatus of claim 13, wherein:
the emitting waveguides and the sensing waveguides extend along a width of the substrate along a direction of an x-axis of the substrate;
the distributing waveguide extends along a length of the substrate along a direction of a y-axis of the substrate orthogonal to the x-axis;
each emitting waveguide includes a plurality of emitting portions;
each sensing waveguide includes a plurality of sensing portions; and
each of the sensing points along a corresponding pair of adjacent emitting and sensing waveguides is associated with the same particular y-coordinate position.

16. The apparatus of claim 15, wherein:
the apparatus is a first apparatus of a display device;
the display device further includes a second apparatus disposed over or with the first apparatus, the second apparatus including:
a plurality of second emitting waveguides that each extend at least partially over the substrate, each second emitting waveguide configured to propagate light to a plurality of corresponding second emitting portions arranged along the second emitting waveguide, each second emitting portion configured to be capable of emitting at least a portion of the light from the second emitting waveguide outwards from the plane defining the substrate; and
a plurality of second sensing waveguides that each extend at least partially over the substrate, each second sensing waveguide including a plurality of second sensing portions arranged along the second sensing waveguide, each sensing portion disposed proximate a corresponding emitting portion, each second sensing portion configured to be capable of receiving light scattered by an object over the corresponding second emitting portion, the second sensing waveguide configured to propagate the received light to a photo-detector; and
wherein:
the second emitting waveguides and the second sensing waveguides extend along the length of the substrate along the direction of the y-axis;
the second apparatus includes a second distributing waveguide that extends along the length of the substrate along the direction of the x-axis; and
each of the sensing points of the second apparatus along a corresponding pair of adjacent second emitting and second sensing waveguides is associated with the same particular x-coordinate position.

17. The apparatus of claim 16, wherein:
the sensing points of the second apparatus are positioned directly over, or are positioned proximately offset from, the sensing points of the first apparatus; and
when an object is suitably positioned on or over at least one sensing point of the first apparatus the object is also positioned over at least one sensing point of the second apparatus such that the processor is configured to determine an x-coordinate position of the object based on information from the second apparatus and to determine a y-coordinate position of the object based on information from the first apparatus.

18. The apparatus of claim 16, wherein the second distributing waveguide of the second apparatus receives light from the light source of the first apparatus and distributes the light to the second emitting waveguides.

19. An apparatus comprising:
light generating means;
photo-detection means;
a substrate;
first guiding means that extend at least partially over the substrate, the first guiding means configured to propagate light from the light generation means to one or more corresponding emitting means arranged along the first guiding means, each emitting means configured to be capable of emitting at least a portion of the light from the first guiding means outwards from a plane defining the substrate; and
second guiding means that extends at least partially over the substrate, the second guiding means including one or more sensing means arranged along the second guiding means, each sensing means arranged proximate a corresponding emitting means, each sensing means configured to be capable of receiving light scattered by an object over the corresponding emitting means, the second guiding means configured to propagate the received light to the photo-detection means.

20. The apparatus of claim 18, wherein each emitting means and each sensing means includes a set of nano-gratings.
